(19) United States
(12) Patent Application Publication
(10) Pub. No.: US 2012/0099801 A1
(43) Pub. Date: Apr. 26, 2012

(54) Sharpness in Digital Images

(76) Inventor: Rodney Shaw, Aptos, CA (US)

(21) Appl. No.: 12/908,161

(22) Filed: Oct. 20, 2010

(51) Int. Cl. G06K 9/40; G06T 17/00

(52) U.S. Cl. 382/263; 345/428

(57) ABSTRACT

A method for enhancing sharpness for a digital image follows this sequence: (a) in a display of a computerized appliance, selecting an image to be enhanced in sharpness; (b) downsizing the selected image by a downsizing algorithm executing on the computerized appliance to produce an image 0 at resolution substantially less than resolution of the original image selected in step (a); (c) applying a convolution filter to image 0 to produce an image n with enhanced sharpness, where n is an integer; (d) subtracting pixel values for pixels of image n from corresponding pixels for image 0, saving the differences; (e) dividing the differences in step (d) by integer n, and saving the quotients; (f) adding the quotients from step (e) to values for corresponding pixels in image 0 to produce an image 1, then to values of pixels for image 1 to produce an image 2, and repeating until an image n-1 is produced; (g) presenting images 0 through n to a user for selection of a best image for sharpness; and (h) upsizing the user-selected image by an upsizing algorithm back to the resolution of the image selected in step (a).

### CROSS-REFERENCE TO RELATED APPLICATIONS

N/A

### BACKGROUND OF THE INVENTION

1. Field of the Invention

The present invention is in the field of apparatus and techniques for enhancing the apparent visual quality of images stored and presented digitally.

2. Description of Related Art

Many techniques exist for processing and filtering images displayed in a computerized system as two-dimensional matrices of pixels, typically presented in a rectangular matrix. A digital display presents pixels in color and brightness according to values stored in memory for each pixel. For color, for example, there will be a separate value in the RGB system for red (R), green (G) and blue (B). In an eight-bit computer process, the values for each pixel for each attribute range from 0 to 255, which is 2⁸. For any of a wide variety of reasons, digital images may be less than optimal in image quality as viewed by a person, and many commercial programs and techniques exist and are available for altering the pixel values to improve the apparent quality of a digital image. To improve the apparent quality of an image, an original image may be altered in one or more of several attributes, such as brightness, contrast, color or what is known in the art as sharpness. The present patent application is in the field of altering sharpness of digital images to improve apparent quality to an observer.

To change apparent sharpness in a pixilated image requires changing individual pixel values in relation to the values of surrounding (proximal) pixels. One technique well known in the art for changing apparent sharpness is controlled application of what are known in the art as convolution filters. References in the art to convolution filters and their uses are numerous. For example RoboRealm at http://www.roborealm.com/help/Convolution.php has a good description of convolution filters and their uses.

Very generally, the way a convolution filter works is that a group of typically adjacent pixels in the image to be enhanced is considered, the group having a central pixel whose value is to be modified, dependent in some fashion on the value of the adjacent pixels. The value of each pixel in the group is multiplied by a pre-determined number, which theoretically may be different for each pixel in the group, the results are added, the sum is divided by the number of pixels in the group (average), the determined average value is divided by a number that is a function of the multipliers for each pixel, and the final value is applied as a new value for the central pixel. The values for the other pixels in the group are not changed. Next the filter is repositioned to have a different central pixel, and asserted again just as above, to determine a new value for the new center pixel, which may be a pixel adjacent to the pixel just previously altered. In this way new values are determined for almost all pixels in the image Edge pixels may be unchanged because of the geometry of the filter, and may be treated separately, such as leaving with the original value, which in practice has little if any noticeable effect on the enhanced image.

In the art of image enhancement, an important consideration is presenting relatively small changes in an image to a person for determination of improvement, because the optimum sharpness is a matter of opinion and viewing conditions. If changes in an image presented to a person are quite large, it is difficult and time consuming to select a preferred image. It is a good idea, therefore, to be able to present enhanced images such that a newly enhanced image differs from an original or a previous enhancement in what the present inventor chooses to call a “just appreciable visual sharpness difference” (JAVSD).

An historic problem with convolution filters for enhancement of apparent sharpness, is that the process is computation intensive, requiring in many cases substantial computer power. Small filters are possible (minimum number of pixels typically nine), and can be defined so the divisor for the last step is one, but the effect of processing an image with such a minimal-computation filter is typically a very large and unacceptable change in sharpness, far beyond what one might consider a JAVSD. To get a small appreciable variation in sharpness, typically a JAVSD, larger filters with much more computational power required have to be used. This is impractical for very large images (many megapixels), or for cameras, iPods, cell phones, and other devices limited in computational power.

What is critically needed in the art of image enhancement is a solution in which minimal-computation filters may be used, and at the same time enhanced images may still be presented to a user in just-appreciable visual differences. Also needed is a way to process very large, high-pixel density (high resolution) with a minimum of computational power, therefore in essentially real time. The present invention provides this much-needed solution.

### BRIEF SUMMARY OF THE INVENTION

The inventor in the present case has considerable experience in image enhancement technology, and has been less than satisfied with the time and computing power necessary to enhance images visually, especially in the attribute of sharpness, as known in the art. As a consequence, the inventor has developed a unique system and process that accomplishes the desired end with a minimum in time and computing power. In this invention, in one embodiment, a method for enhancing sharpness for a digital image is provided, comprising the steps of (a) in a display of a computerized appliance, selecting an image to be enhanced in sharpness; (b) downsizing the selected image by a standard downsizing algorithm executing on the computerized appliance to produce an image 0 at resolution substantially less than resolution of the original image selected in step (a); (c) applying a convolution filter to image 0 to produce an image n with enhanced sharpness, where n is an integer; (d) subtracting pixel values for pixels of image n from corresponding pixels for image 0, saving the differences; (e) dividing the differences in step (d) by integer n, and saving the quotients; (f) adding the quotients from step (e) to values for corresponding pixels in image 0 to produce an image 1, then to values of pixels for image 1 to produce an image 2, and repeating until an image n-1 is produced; (g) presenting images 0 through n to a user for selection of a best image for sharpness; and (h) upsizing the user-selected image by a standard upsizing algorithm back to the resolution of the image selected in step (a).

In one embodiment the convolution filter is a 3×3 filter with multipliers of −1 at all cells but the center cell. Also in one embodiment multiplier at the center cell is 9, producing a divisor of 1 for application of the filter. In some embodiments n=10 or greater.

In another aspect of the invention a system for enhancing sharpness for a digital image is provided, comprising a computerized appliance having a digital display and executing software from a machine-readable medium, the software providing a mechanism enabling a user to select an image to be enhanced, a downsizing algorithm enabling the user to downsize the selected image to a resolution substantially less than the than resolution of the original image selected, a convolution filter and functions for applying the convolution filter to stored images to produce images enhanced for sharpness, and an upsizing algorithm enabling the user to upsize an image to a higher resolution. The user selects an image to be enhanced in sharpness, the image is downsized to produce an image 0 at resolution substantially less than resolution of the original image selected, the convolution filter is applied to image 0 to produce an image n with enhanced sharpness, where n is an integer, the pixel values for pixels of image n are subtracted from corresponding pixels for image 0, saving the differences, the differences are divided by n, saving the quotients, the quotients are added back to the pixel values for image 0 to produce an image 1, and the process is repeated adding the quotients to pixel values of image 1 to produce an image 2, and so forth, until an image n-1 is produced, then images 0 through n are presented to the user for selection of a best image for sharpness, then the selected image is upsized back to the resolution of the original image selected to be enhanced in sharpness.

In one embodiment of the system the convolution filter is a 3×3 filter with multipliers of −1 at all cells but the center cell. Also in one embodiment the multiplier at the center cell is 9, producing a divisor of 1 for application of the filter. In some embodiments n=10 or greater.

In another aspect of the invention a method for enhancing sharpness for a digital image is provided comprising the steps of (a) in a display of a computerized appliance, selecting an image to be enhanced in sharpness; (b) downsizing the selected image by a downsizing algorithm executing on the computerized appliance to produce an image 0 at resolution substantially less than resolution of the original image selected in step (a); (c) applying a convolution filter to image 0 to produce an image n with enhanced sharpness, where n is an integer; (d) subtracting pixel values for pixels of image n from corresponding pixels for image 0, saving the differences; (e) dividing the differences in step (d) by integer n, and saving the quotients; (f) adding the quotients from step (e) to values for corresponding pixels in image 0 to produce an image 1; (g) displaying image 1 to a user and asking for approval; (h) in case of no approval at step (g), adding the quotients from step (e) to the pixel values for image 1 to produce an image 2; (i) repeating building new images by process of steps (g) and (h) until the user selects one as best image; and (j) upsizing the user-selected image by an upsizing algorithm back to the resolution of the image selected in step (a).

In one embodiment of this method the convolution filter is a 3×3 filter with multipliers of −1 at all cells but the center cell. Also in one embodiment the multiplier at the center cell is 9, producing a divisor of 1 for application of the filter. In some cases n=10 or greater.

In yet another aspect of the invention a system for enhancing sharpness for a digital image is provided, comprising a computerized appliance executing software from a machine-readable medium, the software providing a mechanism enabling a user to select an image to be enhanced, a downsizing algorithm enabling the user to downsize the selected image to a resolution substantially less than the than resolution of the original image selected, a convolution filter and controls for applying the convolution filter to stored images to produce images enhanced for sharpness, and an upsizing algorithm enabling the user to upsize an image to a higher resolution.

The user selects an image to be enhanced in sharpness, the image is downsized to produce an image 0 at resolution substantially less than resolution of the original image selected, the convolution filter is applied to image 0 to produce an image n with enhanced sharpness, where n is an integer, the pixel values for pixels of image n are subtracted from corresponding pixels for image 0, saving the differences, the differences are divided by n, saving the quotients, the quotients are added back to the pixel values for image 0 to produce an image 1, image 1 is displayed to the user to approve or not as a best image for sharpness, in the case of no approval the saved quotients are added to the pixel values of image 1 to produce an image 2, which is displayed to the user for approval, and the process is repeated until the user selects an image as the best image for sharpness, then the selected image is upsized back to the resolution of the original image selected to be enhanced in sharpness.

In one embodiment the convolution filter is a 3×3 filter with multipliers of −1 at all cells but the center cell. Also in one embodiment the multiplier at the center cell is 9, producing a divisor of 1 for application of the filter. In some embodiment n=10 or greater.

In still another aspect of the invention a method for producing a sequence of images enhanced for sharpness is provided, comprising the steps of (a) selecting an image to be enhanced as image 0, (b) applying a convolution filter to image 0 to produce an image n with enhanced sharpness, where n is an integer, (c) subtracting pixel values for pixels of image n from corresponding pixels for image 0, saving the differences, (d) dividing the differences in step (c) by integer n, and saving the quotients, and (e) adding the quotients from step (d) to values for corresponding pixels in image 0 to produce an image 1, then to values of pixels for image 1 to produce an image 2, and repeating until an image n-1 is produced.

In one embodiment there is a further step for presenting the images as a sequence of images to a user for selection of one of the images as a best image for sharpness.

### BRIEF DESCRIPTION OF THE SEVERAL VIEWS OF THE DRAWINGS

FIG. 1 FIG. 1 is a representation of geometry and placement of a 3×3 convolution filter 102 in the art.

FIG. 2 is an enlarged view of the filter of FIG. 1, with associated values, to illustrate the computational procedure for asserting the filter at one position.

FIG. 3 is a representation of how the filter of FIG. 1 might be moved over an image to produce heightened sharpness for the entire image.

FIG. 4 FIG. 4 illustrates a computerized appliance having Internet connection via a wireless network that communicates with a station, thence through a gateway to the Internet backbone, which represents all of the network interconnections in the Internet network.

FIG. 5 illustrates a process for selectively enhancing sharpness of relatively large images in a minimum amount of time, using devices of limited computational power.

FIG. 6 is a process flow diagram (flow chart) illustrating steps in a process according to a preferred embodiment of the present invention.

FIG. 7 is a flow diagram illustrating a process for batch processing of similar images in an embodiment of the present invention.

FIG. 8 is a diagram for use in preferential sharpening in different segments of an image in an embodiment of the present invention.

FIG. 9 is a flow diagram depicting a process for preferential sharpening in segments based on local pixel value averages indicating relative lightness or darkness in the image in the local vicinity.

### DETAILED DESCRIPTION OF THE INVENTION

Convolution filters are spatial filters. Spatial filtering is the filtering of an image in the spatial domain. That is, the value of each pixel of the image is modified in contextual relationship to values of neighboring pixels. Consider, for example, a digital image of 320 rows and 480 columns, having a total of 1.536×10⁵ pixels. The smallest grouping of pixels which associates one pixel with all of its nearest neighbors is typically a 3×3 matrix of nine pixels, in which a central pixel is seen surrounded by its eight nearest neighbors.

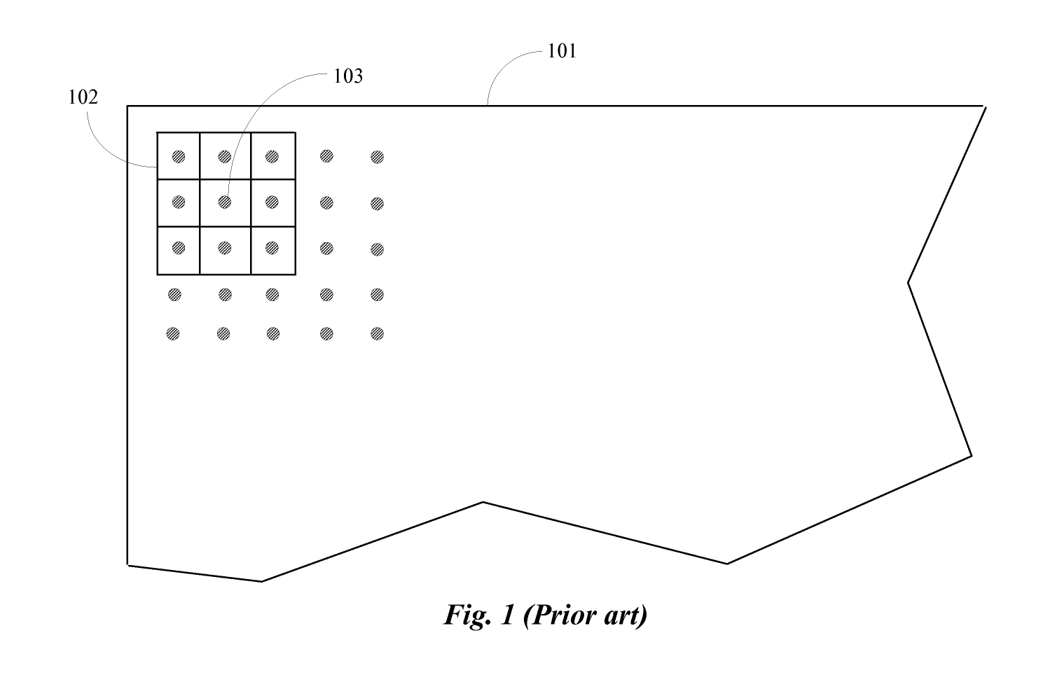

FIG. 1 is a representation of geometry and placement of a 3×3 convolution filter 102 in the art, centered on a pixel 103 in the upper left corner of a portion of a pixilated image 101. The rectangular geometry of filter 102 is seen to relate a central pixel 103 to its eight surrounding closest neighbors. Only a small number of pixels at exaggerated spacing distance is shown for image portion 101.

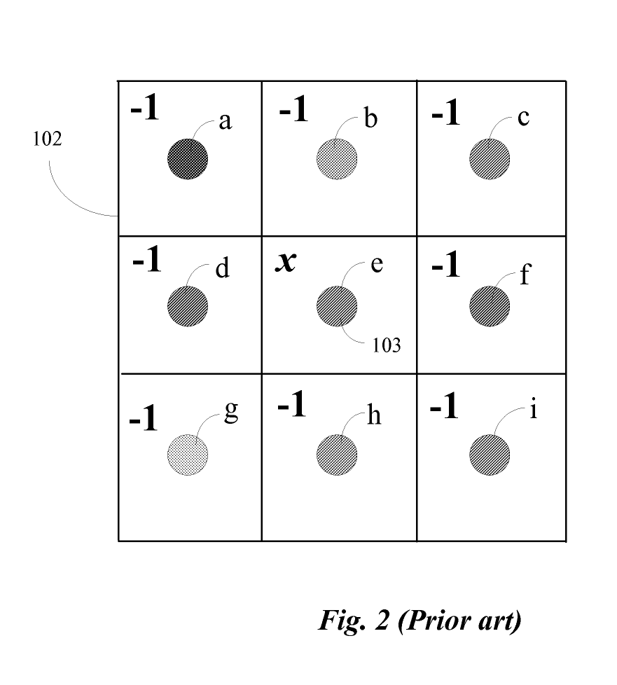

FIG. 2 is an enlarged view of the filter of FIG. 1, with associated values, to illustrate the computational procedure for asserting the filter at one position. In this representation each of the nine pixels associated in the 3×3 filter pattern has been given a lower-case letter, a through i. Pixel e in this case is the center pixel 103 for which the value will be changed in one assertion of the filter. Each of the nine positions in the pattern has also been associated with a signed multiplier, which is +x for pixel e (103), and −1 for each of the surrounding pixels. These numbers are multipliers in an algorithm associated with the filter. Theoretically all of the multipliers may have unique values, but for reasons of efficacy and by experience −1 is an appropriate choice for the eight surrounding pixels. This multiplier is not the original pixel value at each position, but a multiplier to be applied to the pixel value at that position each time the filter is asserted.

The procedure for the filter we are considering operates as follows:
(1) Determine the algebraic sum of the multipliers. This number is set aside as a divisor for step (3) below. In the example of FIG. 2 this divisor is −8+x.
(2) Multiply each pixel value by the assigned multiplier and take the algebraic sum of the results (-a-b-c-d+xe-f-g-h-i)
(3) Divide this result by the divisor determined in step (1) above.
(4) Replace the pixel value e by this new pixel value
(5) Move the filter to determine a new pixel value for another center pixel.

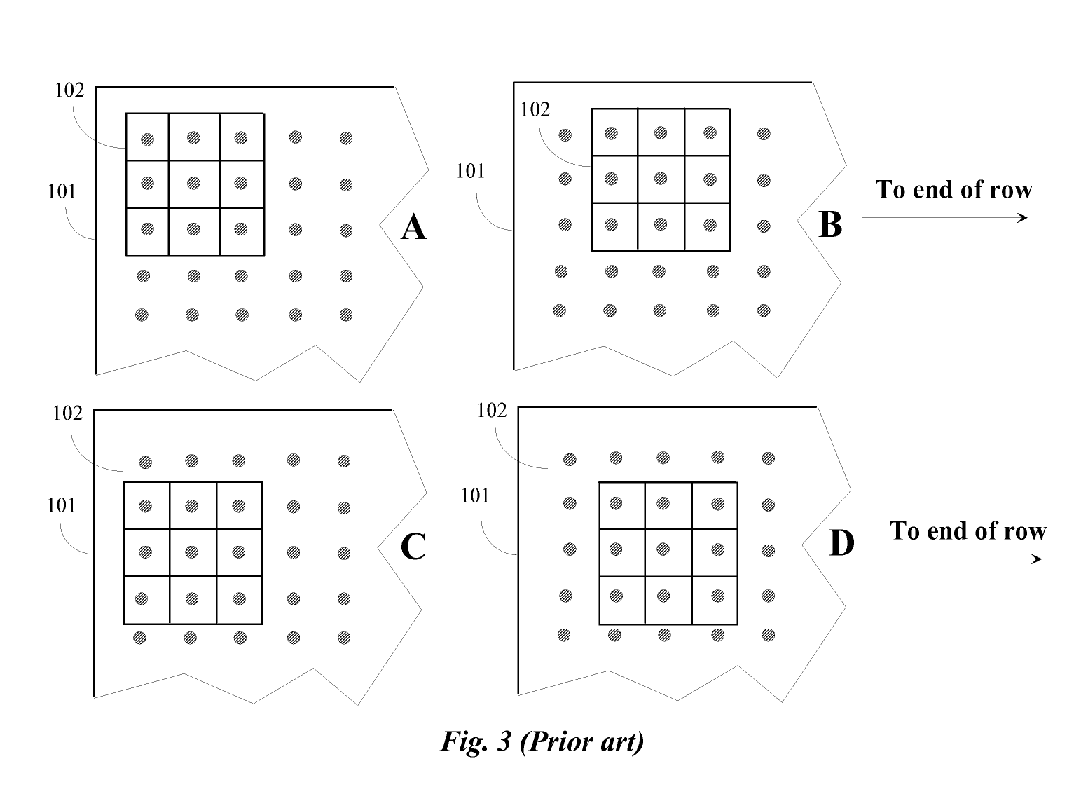

FIG. 3 is a representation of how the filter of FIG. 1 might be moved over an image to produce heightened sharpness for the entire image. First the filter is applied at the upper left corner of the image (A), over a center pixel that is the second pixel in the second row. The filter procedure is applied for that center pixel, then the filter is moved one pixel distance to the right (B), and applied to change the value for the third pixel in the second row. This move and calculate procedure is repeated for all the pixels in the second row, then the filter returns to the second column centered on the second pixel in the third row (C). Then the filter is moved sequentially one pixel at a time through the third row. This row-by-row procedure continues until all new pixel values are determined that can be determined given the geometry of the filter. Now a new image is stored that has enhanced sharpness compared to the original image.

The skilled artisan will recognize, of course, that the concept of a 3×3 filter with multipliers assigned to each cell in the filter is just a convenient concept. What actually happens is that a software routine, executing from a machine-readable medium coupled to a computer appliance, consults a mapping of values in memory for an original image that is to be modified by the algorithm, selects the appropriate values that are associated with nine adjacent pixels, performs the steps of the algorithm, stores the new center pixel value in memory for a new image, and then selects a new mapping of nine adjacent pixels (moves the filter). If the pixel groups are selected in a manner that every pixel that may be the center pixel of a 3×3 mapping, then new values will be determined a stored for all pixels in the original image, except edge pixels.

Also a part of the algorithm is a step dictating that if a new value for a pixel is determined to be zero or less than zero, zero is used; and if a new value is determined that is greater than the maximum allowed (255 for an eight-bit computing machine), then 255 is used.

Given the procedure above for applying the convolution filter, it will be apparent to the skilled person that in step (1), if one chooses 9 for the multiplier in the center cell (x), than the divisor for step (3) is 1, and in effect step (3) may be skipped; a bonus in computation efficiency.

It is rather well-known in the art that a 3×3 convolution filter with −1 as a multiplier for the surrounding pixels is an appropriate choice to minimize computation intensity, but to provide differences in sharpness in an altered image from an original that is not too extreme, it is necessary to use a multiplier x that will require a division step with a divisor greater than 1. Using 9 for x generates an amended image that has dramatic enhanced sharpness. To produce an image enhanced for sharpness by a JAVSD, it is necessary to use a much larger number for x. In practice it is seen that x needs to be about 18, producing a divisor of 10, to produce a sharpness-enhanced image at JAVSD. A typical user, however, will not be satisfied with viewing just a first enhanced image. A user will typically want to see images enhanced step-by-step, until it is apparent the image is too sharp. Then the user may back down to the just previous image as the best choice.

To accomplish this in the art, assuming that x=18 produces a JAVSD, requires that an enhanced image be produced by applying the filer with x=18 (divisor 10) at all positions that can be attained. Then a second enhanced image is produced with x=17 (divisor 9), and so on (x=16, 15, 14 . . . ), until the user discovers the new image is too sharp. This may require four or more image iterations with a new divisor greater than 1 for each. The skilled person will understand that the original image needs to be saved, and each enhanced image produced from the original or from a previously enhanced image also needs to be saved, and functionality needs to be provided for the user to select any one of the images as the preferred image for sharpness.

The process described above for producing and displaying enhanced images to a viewer for selection to produce an image with preferred sharpness, is still quite computationally intensive.

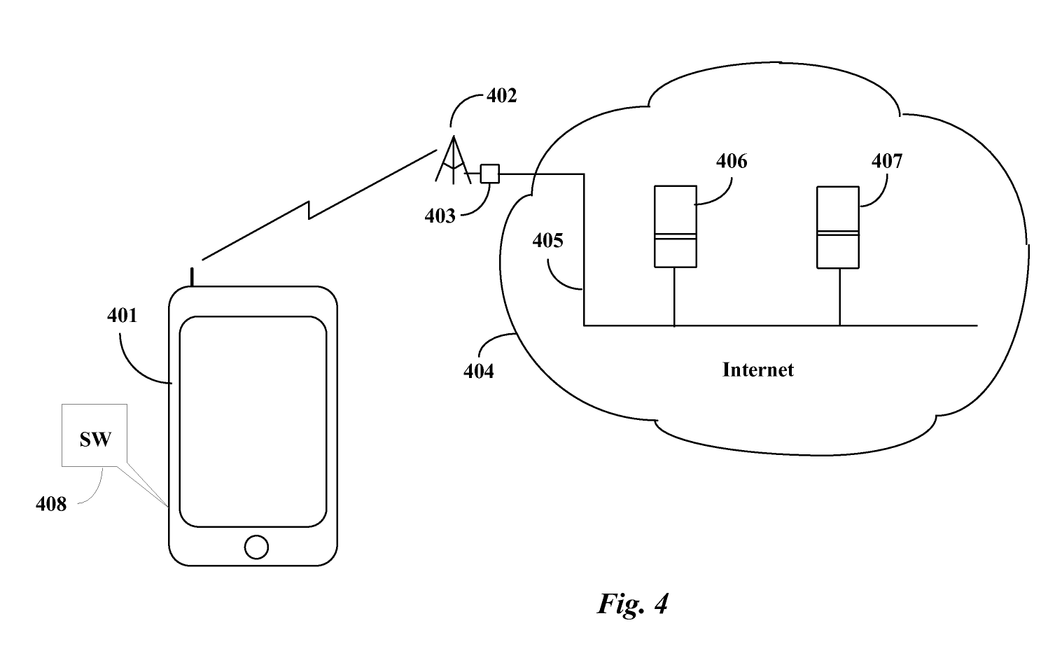

FIG. 4 illustrates a computerized appliance 401 having Internet connection via a wireless network that communicates with a station 402, thence through a gateway 403 to Internet backbone 405, which represents all of the network interconnections in the Internet network. Two Internet-connected servers 406 and 407 are shown representing all of the sites in the Internet network which may serve information and data to internet-connected appliances like appliance 401. Appliance 401 may be a cellular telephone, a personal digital assistant, or any other Internet connectable appliance. In some cases appliance 401 may be a laptop or desktop computer, or an iPad device. Internet connection is represented in FIG. 4 as a means by which appliance 401 may receive images, however, in some embodiments of the invention there may be no Internet connection, and images may be loaded to the appliance by any other known data transfer technique.

The skilled person will understand that appliance 401 will have a CPU and a display, and will be capable of executing software 408 stored in local memory, without this specification detailing the well-known components used in computerized appliances for displaying images, and for executing software that may alter pixel values and display altered images from original images stored in memory coupled to the device.

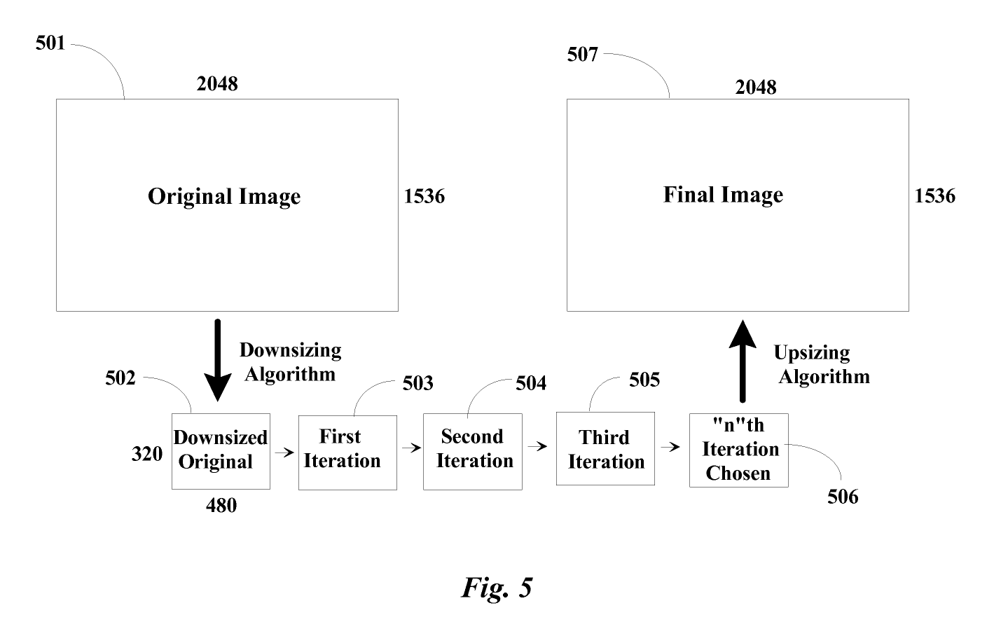

FIG. 5 illustrates a process for selectively enhancing sharpness of relatively large images in a minimum amount of time, using devices of limited computational power. It is well-known that the tendency in the art, due in part to the ever-descending cost of memory and greater resolution in displays, is to images of higher resolution. Given the descriptions above regarding the computational intensity of sharpness enhancement, images of higher and higher resolution present an ever bigger problem in time and computing power. There are, however, quite good downsizing algorithms available to render high-resolution images at lower resolution. One site that deals with this issue is http://www.thephotofinishes.com/plugrevupsize.htm.

So a first step in sharpness enhancement in an embodiment of the present invention is to downsize the image desired to be enhanced. In FIG. 5 image 501 is an image for which a user desires enhanced sharpness. This image is represented as 2048×1536, which is 3,145,728, or 3.146 mega-pixels. This particular size is used only for exemplary purpose, and could be any image of high-resolution. A first step is downsizing this image to a lower resolution, using a commercially available downsizing algorithm.

In this example image 501 is downsized to 480×320, or 153,600 pixels, about 5% of the number of pixels in the larger image. The skilled person will recognize that the visual quality of downsized image 502 will be essentially the same as the image 501, as long as the display is presented without too much magnification. The smaller image will be quite satisfactory for a user to make judgments as to the quality of sharpness. A very big advantage is that application of a convolution filter to the smaller image will have to deal with only one pixel in twenty of the larger image, and can operate either twenty times quicker, or with far less computing power in the same time frame.

The next step in this unique process is running a minimal-computation convolution filter over the smaller image in several steps to create a series of altered images with just-appreciable visual difference from one image to the next, to create a series of enhanced images 503, 504, 505 506. There is a unique difference in the way this is done in this example than in the prior art. In this embodiment the 3×3 filter with surrounding multipliers of −1 and x=9 is used this provides for the minimum computation, because the divisor for step (3) on page 5 above will be 1, which allows us to skip that step.

The result of the single pass of the minimal convolution filter, however is that the sharpness change will be quite dramatic, as described previously above, beyond what most users would select as a desirable improvement. In this embodiment this is handled in a unique way. The pixel vales for the original image are saved as image 0, and the first enhanced image is treated as image 10. Now our system takes, for each pixel, the difference between the pixel value for image 10 and the pixel value for image 0, and divides by ten. These differences are algebraically added back to image 0 to produce image 1, an image with a just appreciable visual difference in sharpness from image 0. Adding the differences to the pixel values for image 1 produces image 2, an image with a JAVSD from image 1, and a greater difference in sharpness from image 0. The process is repeated through image 9. Image 10 already exists as the result of applying the convolution filter to image 0.

We now have a series of ten images, each differing from its immediate neighbors by JAVSD. A user may easily select the image that appears to be the best (in the eye of the beholder) for sharpness.

It is not required that there be ten iterations. There may be five, or six, or four; but there needs be several, so the user has a selection of several images from which to choose. If the selection is too sparse, the best image to the user might well be between two of the iterations presented. That is, one will appear to the user to be not sharp enough, and an adjacent iteration will appear too sharp.

Once the “best” image is chosen by the user, it is needed to provide that result to the larger resolution, which in this example is 2048×1536. In the prior art the process would dictate that the filter be applied to the larger image. But in this embodiment of the invention the best smaller image is simply upsized by a commercially-available algorithm that has been determined to be appropriate. The result has been shown by the inventor to be equal in quality to the prior art method of applying more computation-intensive filters to the larger image, a process perhaps requiring orders of magnitude more power and time.

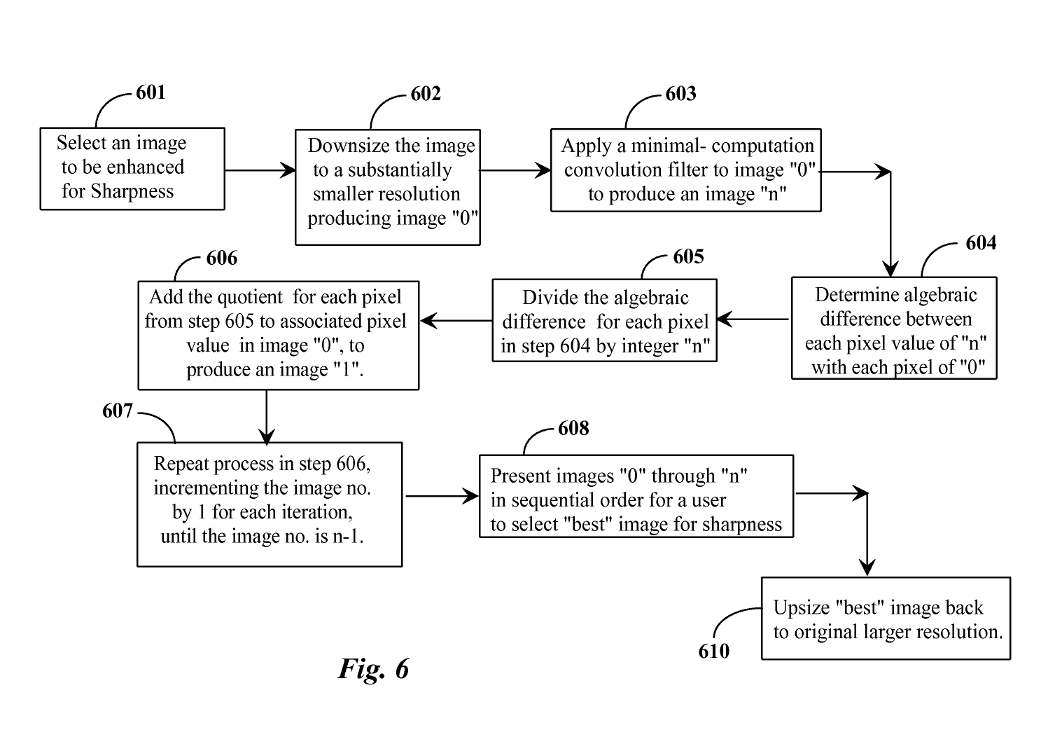

FIG. 6 is a process flow diagram (flow chart) illustrating steps in a process according to a preferred embodiment of the present invention, much as described above. At step 601 an image is selected to be enhanced for sharpness. At step 602 the image is downsized by applying a commercially-available downsizing algorithm, to a resolution substantially less than the resolution of the original image selected in step 601, providing an image 0 (502 in FIG. 5). At step 603 a convolution filter is applied to the reduced-resolution image to form a first image with enhanced sharpness (image 1-503 in FIG. 5). At step 604 the algebraic difference in value between the pixel values for image 1 and the original downsized image is determined. This algebraic difference is divided by an integer n in step 605. At step 606 the quotient for each pixel is added to the pixel value for image “0” to produce a second enhanced image 2. At step 607 the same quotient for each pixel from step 605 is added to the pixels of image 2 to produce a third enhanced image 3. Step 707 is repeated to add values to pixels of image 3, and so on, until an image n−1 is produced. At this point there are n enhanced images (0 to n), each displaying a JAVSD with the one before. These may be displayed to a user, preferably in order, and the user is invited to select the image judged to be the best for sharpness. This is then upsized in the final act back to the original resolution of the larger image that was first considered to be enhanced for sharpness. This final image may be saved.

The skilled person will recognize that the embodiments described herein may be altered in several ways within the scope of the invention. The size of the “larger” image is not a fixed value, for example, but can be any one of a wide variety of resolutions. The downsizing and upsizing algorithms are not fixed, but may be chosen from a variety of readily-available and well-known algorithms. The size of the “smaller” image is not fixed either, but may vary over a wide range. The smaller image is preferably considerably smaller than the larger to effectively limit the number of pixels necessary to recalculate in filter application. The number of iterations from image 0 to a final image, each of which is produced by a single pass of the filter, is also not fixed, but is preferably at least four, and more preferably eight or ten.

Another variation in the process might involve producing one alteration at a time, and allowing the user to judge the new image before going on to a next. For example, the system might present the first alteration to the user and wait for a signal to produce the next, and then wait for a signal to produce another. The user may have access as well to a “back” command, and to a command to compare the image with the original, so when an image is presented that is slightly too sharp, the back command will revert to the just previous image, and the user may then cause that image to be selected and upsized to the original resolution. There are many similar possibilities.

### Batch Processing

In another aspect of the present invention it may be desirable to do batch processing, that is, to apply the process described above in different examples to a plurality of digital images. A user may have, for example, a plurality of images of very similar characteristics, such as a group of images captured by a digital camera in a relatively short period of time, under similar circumstances of lighting, and without changing settings on the camera, and displayed on the same monitor, perhaps a computer display monitor.

Referring now to FIG. 6 and to the description of FIG. 6 above, and not considering the downsizing or upsizing of an image, a process is described wherein a minimal convolution filter is sequentially applied over the pixels of an image to be enhanced (image 0), producing pixel values for an image “n”. Sharpness is thus enhanced for image “n”, but the change (increase) in sharpness will typically be more than might be desired. In this process the algebraic difference between the value for each original pixel and the value for the pixel in the same position in the image for image “n” is determined, and then the difference is divided by an integer. The integer may be theoretically any integer, but the idea is to produce images between image 0 and image “n”, in which there is just an appreciable visual difference. So this integer value may be 10, for example, and 10 is set as “n”.

The pixel value differences at each pixel position is divided by the integer, then an image 1 is produced by adding to the pixel values at each pixel position for image 0 one-tenth of the difference between the pixel value for image 0 and the pixel value for the same pixel in image 10. Similarly an image 2 is produced adding 2 times the difference at each pixel position, an image 3 using 0.3 times the difference, and so on, producing images 1 through 9 between image 0 and image 10, each successive image having a sharpness increase of just an appreciable visual difference. These ten images are displayed to a user, the user enabled to select the “best” image, that is, the one that seems to have, for that user, the optimum quality of sharpness.

Assume now that this unique process is followed for one image of a plurality of images of very similar characteristics by a user, and the user selects image 3 as the optimum image sharpness. It may be assumed, then, that the image 3 for all of the plurality of images will be, for this user, the image with the optimum sharpness. It will not be necessary to produce image 1, 2, or 4 through 9 for any of the other images of the plurality. Having selected the plurality of images and initiated a batch process, the batch system in this embodiment will produce the ten images for the user, and enable selection of the “best” image for the user, and then use the image selected (1st, 2nd, 3rd, etc.), to produce a sharpness-enhanced image for all of the other images of the plurality.

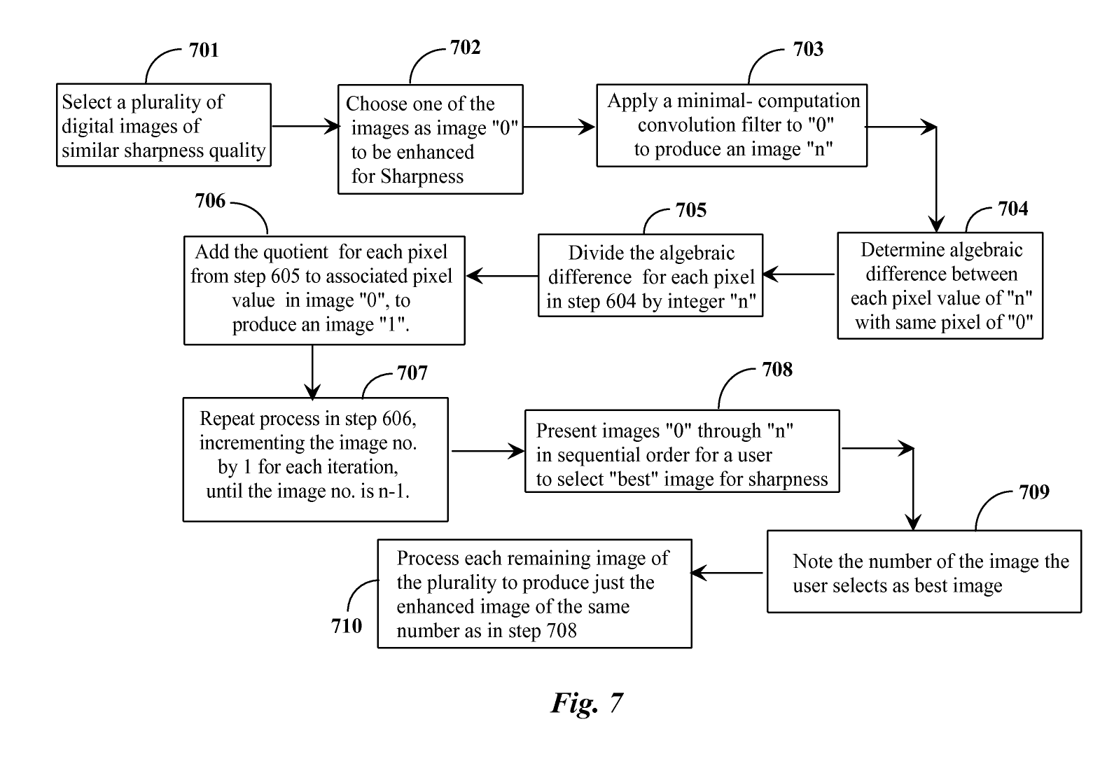

FIG. 7 is a process flow diagram for the batch processing process described just above, in which steps 702 through 708 repeat the process described with reference to FIG. 6 for one image. Step 701 is a first step for selecting the first image to be enhanced from a plurality of similar images. Step 709 is for noting the number of the image chosen by the user as the optimum image for sharpness, and step 710 repeats the process for every other image of the plurality, but to produce only the image of the number selected. So it is only necessary to produce all of the images for selection just once, then all of the other enhanced images may be produced automatically.

Another example of batch processing in sharpness enhancement is in the area of video technology. It is well-know that data streams for video are arranged to produce successive frames in display, much in the manner of movie film presenting a rapidly-changing sequence of still images, each slightly altered from the previous. Typically all of the frames in a video data stream will have very similar sharpness characteristics. If one selects, then, just one frame, applies the process described above to the one frame, and a user selects one of the candidate sharpness-enhanced images as the most appropriate, then further processing may be truncated for all the other frames. Assume, for example, that the process is applied to one frame, providing ten candidate images of that frame, each with a JAVSD from the immediately preceding image, and the user selects image four. One may safely assume that image four will be appropriate for all the other frames of the video as well and the original image for each frame may then be processed to produce the fourth image, without producing all of the other candidate images.

### Selective Segmentation in Image Sharpening

The processes described thus far in this specification apply the same process in sharpness enhancement to every part of an image. The skilled artisan will understand that in some cases a user may prefer to preferentially enhance sharpness in particular segments of an image. In one instance, for example, a user may prefer to sharpen an image preferentially in segments that are in shadow. In another instance a user may prefer to sharpen an image preferentially in segments that are highlighted, that is in brightness. In yet another instance a user may prefer to sharpen an image preferentially in segments that are in midrange of brightness. Other similar preferences are possible.

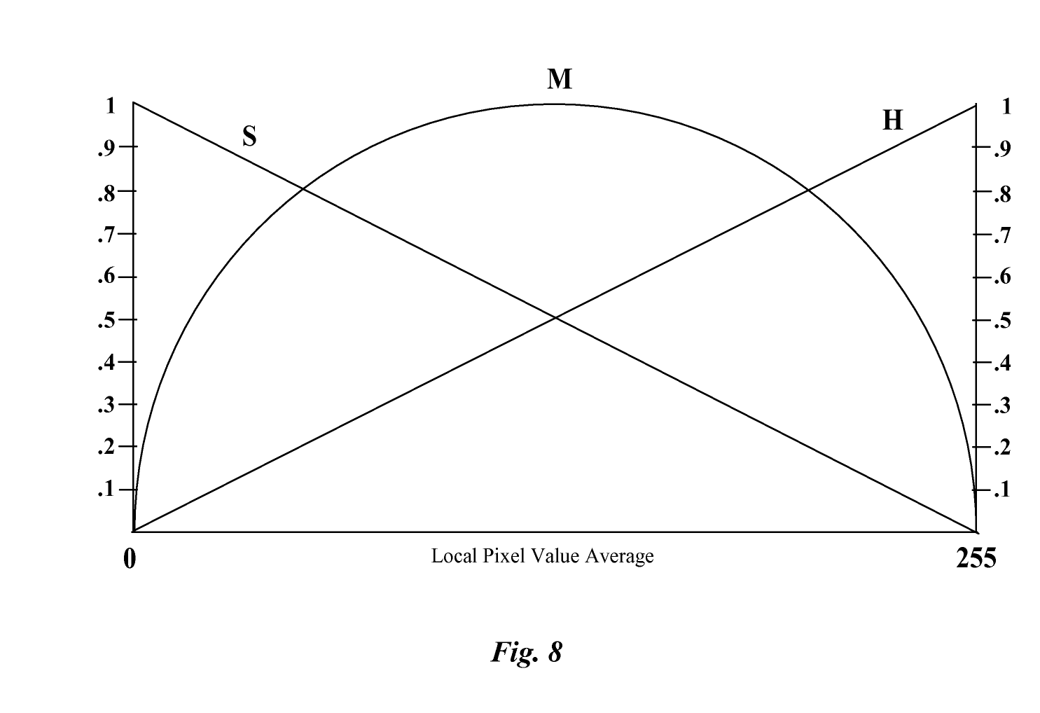

Therefore, in another aspect of the present invention, a process is provided that treats different segments of an image differently, according the local brightness characteristics. FIG. 8 is a diagram that relates average local pixel value from 0 to 255 (assuming an eight-bit display system) for brightness to a vertical scale between 0 (at origin) and 1. In FIG. 8 there is a straight line labeled S for use in a process to sharpen preferentially in segments that are in shadow. A straight line labeled H is for use in a process to sharpen preferentially in segments of an image highlighted. A curve M is for use in a process to sharpen preferentially in midtone segments.

Assume for a first example that a user wants to sharpen preferentially in segments that are in shadow. The process is very similar to that described above as conventional art for producing an image n from an original image 0, in which a convolution filter is applied sequentially to values for pixels of image 0 to produce image n. In this new and non-conventional procedure, however, at each application of the filter, in addition to producing a new pixel value for image n, the pixel values for each cell of the filter (nine cells for a three by three filter) are added and divided by the number of the cells, rendering a pixel value average for the cells in the vicinity of the center cell being altered in value by the filter protocol. This average pixel value expresses the nature of the segment in which the object pixel resides; that is, light, dark or midtone.

Now, in this preferential process for sharpening in shadow, the system utilizes the graph of FIG. 8, and line S. Note that for a local pixel value average of zero (fully dark, extreme shadow) the graph expresses 1, and for a local pixel value average of 255 (fully bright) the graph expresses zero, and for local averages in between, the value from the graph is between 0 and 1 proportionally.

At every position for application of the filter the local average pixel value is determined, and the new pixel value determined by the filter protocol is used to determine the pixel value difference for that pixel position, and the difference is multiplied by the value from the graph and added back for the new pixel value.

It will be apparent to the skilled person that this procedure, using the line S, will preferentially sharpen in segments that a dark, and will sharpen less in segments that are more light.

If it is desired to sharpen preferentially in areas that are light, then in the process the line H is used from the graph of FIG. 8, and sharpness will be preferential for light segments, and less for dark segments. If it is desired to sharpen in mid-tone segments, the curve M will be used, so maximum effect will accrue for local averages near midtone (halfway between 0 and 255), and there will be little effect near deep shadow or extreme brightness, and the effect will demonstrate uniform differences, because the curves are well-behaved.

It will be apparent to the skilled person that a graph may be created for just about any segment enhancement. M may be inverted, for example, to sharpen preferentially in both deep shadow or extreme brightness, but not at all at mid-tone. The skilled person will also understand that the graph of FIG. 8 is used to illustrate the process, but that in practice values will be picked from tables relating local pixel value averages to decimal fractions between 0 and 1.

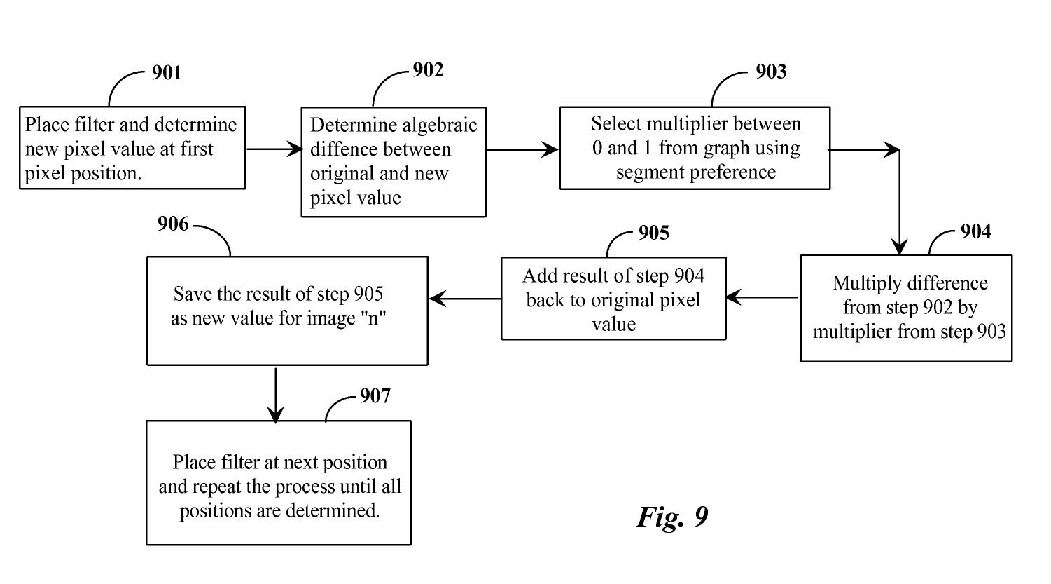

FIG. 9 is a flow diagram depicting the process just described for preferential sharpening in segments based on local pixel values averages indicating relative lightness or darkness in the image in the local vicinity. At step 901 the convolution filter is applied for a first pixel in the original image “0”. At step 902 the algebraic difference between the original pixel value at the first position and the new pixel value is determined. At step 903 a multiplier is selected according to the graph using the relationship for a segment preference. At step 904 the difference from step 902 is multiplied by the multiplier from step 903. At step 905 the result of step 904 is added back to the original pixel value. At step 906 the result of step 905 is saved as the new pixel value for image “n”. At step 907 the filter is moved to a new position and the process is repeated until new pixel values are determined for all of the pixel positions.

It will be apparent to the skilled person that there are many alterations that might be made to embodiments described as examples herein, all within the scope of the invention, which is limited only by the claims that follow.

1. A method for enhancing sharpness for a digital image, comprising the steps of:
(a) in a display of a computerized appliance, selecting an image to be enhanced in sharpness;
(b) downsizing the selected image by a downsizing algorithm executing on the computerized appliance to produce an image 0 at resolution substantially less than resolution of the original image selected in step (a);
(c) applying a convolution filter to image 0 to produce an image n with enhanced sharpness, where n is an integer;
(d) subtracting pixel values for pixels of image n from corresponding pixels for image 0, saving the differences;
(e) dividing the differences in step (d) by integer n, and saving the quotients;
(f) adding the quotients from step (e) to values for corresponding pixels in image 0 to produce an image 1, then to values of pixels for image 1 to produce an image 2, and repeating until an image n-1 is produced;
(g) presenting images 0 through n to a user for selection of a best image for sharpness; and
(h) upsizing the user-selected image by an upsizing algorithm back to the resolution of the image selected in step (a).

2. The method of claim 1 wherein the convolution filter is a 3×3 filter with multipliers of −1 at all cells but the center cell.

3. The method of claim 2 wherein the multiplier at the center cell is 9, producing a divisor of 1 for application of the filter.

4. The method of claim 1 wherein n=10.

5. A system for enhancing sharpness for a digital image, comprising:
a computerized appliance having a digital display and executing software from a machine-readable medium, the software providing:
a mechanism enabling a user to select an image to be enhanced;
a downsizing algorithm enabling the user to downsize the selected image to a resolution substantially less than the than resolution of the original image selected;
a convolution filter and functions for applying the convolution filter to stored images to produce images enhanced for sharpness; and
an upsizing algorithm enabling the user to upsize an image to a higher resolution;
wherein the user selects an image to be enhanced in sharpness, the image is downsized to produce an image 0 at resolution substantially less than resolution of the original image selected, the convolution filter is applied to image 0 to produce an image n with enhanced sharpness, where n is an integer, the pixel values for pixels of image n are subtracted from corresponding pixels for image 0, saving the differences, the differences are divided by n, saving the quotients, the quotients are added back to the pixel values for image 0 to produce an image 1, and the process is repeated adding the quotients to pixel values of image 1 to produce an image 2, and so forth, until an image n−1 is produced, then images 0 through n are presented to the user for selection of a best image for sharpness, then the selected image is upsized back to the resolution of the original image selected to be enhanced in sharpness.

6. The system of claim 5 wherein the convolution filter is a 3×3 filter with multipliers of −1 at all cells but the center cell.

7. The system of claim 6 wherein the multiplier at the center cell is 9, producing a divisor of 1 for application of the filter.

8. The system of claim 1 wherein n=10.

9. A method for enhancing sharpness for a digital image, comprising the steps of:
(a) in a display of a computerized appliance, selecting an image to be enhanced in sharpness;
(b) downsizing the selected image by a downsizing algorithm executing on the computerized appliance to produce an image 0 at resolution substantially less than resolution of the original image selected in step (a);
(c) applying a convolution filter to image 0 to produce an image n with enhanced sharpness, where n is an integer;
(d) subtracting pixel values for pixels of image n from corresponding pixels for image 0, saving the differences;
(e) dividing the differences in step (d) by integer n, and saving the quotients;
(f) adding the quotients from step (e) to values for corresponding pixels in image 0 to produce an image 1;
(g) displaying image 1 to a user and asking for approval;
(h) in case of no approval at step (g), adding the quotients from step (e) to the pixel values for image 1 to produce an image 2;
(i) repeating building new images by process of steps (g) and (h) until the user selects one as best image; and
(j) upsizing the user-selected image by an upsizing algorithm back to the resolution of the image selected in step (a).

10. The method of claim 9 wherein the convolution filter is a 3×3 filter with multipliers of −1 at all cells but the center cell.

11. The method of claim 10 wherein the multiplier at the center cell is 9, producing a divisor of 1 for application of the filter.

12. The method of claim 9 wherein n=10.

13. A system for enhancing sharpness for a digital image, comprising:
a computerized appliance executing software from a machine-readable medium, the software providing:
a mechanism enabling a user to select an image to be enhanced;
a downsizing algorithm enabling the user to downsize the selected image to a resolution substantially less than the than resolution of the original image selected;
a convolution filter and controls for applying the convolution filter to stored images to produce images enhanced for sharpness; and
an upsizing algorithm enabling the user to upsize an image to a higher resolution;
wherein the user selects an image to be enhanced in sharpness, the image is downsized to produce an image 0 at resolution substantially less than resolution of the original image selected, the convolution filter is applied to image 0 to produce an image n with enhanced sharpness, where n is an integer, the pixel values for pixels of image n are subtracted from corresponding pixels for image 0, saving the differences, the differences are divided by n, saving the quotients, the quotients are added back to the pixel values for image 0 to produce an image 1, image 1 is displayed to the user to approve or not as a best image for sharpness, in the case of no approval the saved quotients are added to the pixel values of image 1 to produce an image 2, which is displayed to the user for approval, and the process is repeated until the user selects an image as the best image for sharpness, then the selected image is upsized back to the resolution of the original image selected to be enhanced in sharpness.

14. The system of claim 13 wherein the convolution filter is a 3×3 filter with multipliers of −1 at all cells but the center cell.

15. The system of claim 14 wherein the multiplier at the center cell is 9, producing a divisor of 1 for application of the filter.

16. The system of claim 13 wherein n=10.

17. A method for producing a sequence of images enhanced for sharpness, comprising the steps of:
(a) selecting an image to be enhanced as image 0;
(b) applying a convolution filter to image 0 to produce an image n with enhanced sharpness, where n is an integer;
(c) subtracting pixel values for pixels of image n from corresponding pixels for image 0, saving the differences;
(d) dividing the differences in step (c) by integer n, and saving the quotients; and
(e) adding the quotients from step (d) to values for corresponding pixels in image 0 to produce an image 1, then to values of pixels for image 1 to produce an image 2, and repeating until an image n−1 is produced.

18. The method of claim 17 comprising a further step for presenting the images as a sequence of images to a user for selection of one of the images as a best image for sharpness.
